(19) United States
(12) Patent Application Publication
(10) Pub. No.: US 2013/0144609 A1
(43) Pub. Date: Jun. 6, 2013

(54) TEXT PROCESSING SYSTEM, TEXT PROCESSING METHOD, AND TEXT PROCESSING PROGRAM

(71) Applicants: Seiya Osada, Tokyo (JP); Ken Hanazawa, Tokyo (JP); Takayuki Arakawa, Tokyo (JP); Koji Okabe, Tokyo (JP); Daisuke Tanaka, Tokyo (JP)

(72) Inventors: Seiya Osada, Tokyo (JP); Ken Hanazawa, Tokyo (JP); Takayuki Arakawa, Tokyo (JP); Koji Okabe, Tokyo (JP); Daisuke Tanaka, Tokyo (JP)

(73) Assignee: NEC CORPORATION, Tokyo (JP)

(21) Appl. No.: 13/814,611

(22) PCT Filed: Aug. 2, 2011
(86) PCT No.: PCT/JP2011/068008

§ 371 Date: Feb. 6, 2013

(30) Foreign Application Priority Data
Aug. 19, 2010 (JP) 2010-183996

(51) Int. Cl. G06F 17/21

(52) U.S. Cl. CPC G06F 17/21
USPC 704/9

(57) ABSTRACT

Provided is a text processing system capable of avoiding declining processing efficiency in analyses of text that does not contain breaks.

This text processing system comprises: a linking means for generating linking data that links acquired text after the link object analysis result, which are the results of the analysis of text acquired prior to the acquired text; an analysis means for carrying out language analysis on the linked data, using at least a portion of the link object analysis result; and a determination means for determining a prescribed unit break included in the linked data, on the basis of the results of the analysis by the analysis means.

The link object analysis results are the results of the analysis after the break that is determined by the determination means.

The link object analysis results are the results of the analysis after the break that is determined by the determination means.

### FIELD OF THE INVENTION

The present invention relates to a text processing system, a text processing method and a text processing program which process a text.

### BACKGROUND OF THE INVENTION

A text processing system for processing a text breaks apart a text into sentence elements and analyzes it (For example, refer to patent document 1). Further, the text processing system recognizes a break of a sentence (For example, refer to patent document 2).

Also known well is a text processing system which performs speech recognition of a sound streaming in almost real time and performs text processing for each prescribed unit. A text processing system that uses such speech recognition needs to find breaks of a prescribed unit of a stream-like text such as a speech recognition result that does not include punctuation marks with high accuracy.

However, patent document 1 one that assigns a plurality of grammatical rules to divided sentence elements, and thus it cannot find a break of a stream-like text with high accuracy.

Also, patent document 2 needs communication between a terminal of one's own side and a dialogue translation main unit, and thus processing in real time is difficult.

Accordingly, as a text processing system that finds a break of a prescribed unit of a stream-like text with high accuracy, there is one that analyzes a clause boundary. (For example, refer to non-patent document 1)

Non-patent document 1 analyzes dependency based on a clause boundary, and determines a unit for summarization.

[Patent document 1] Japanese Patent Application Laid-Open No. 2010-079705

[Patent document 2] Japanese Patent Application Laid-Open No. 1992(H4)-055978

[Non-patent document 1] Tomohiro Ohno, Shigeki Matsubara, Hideki Kashioka, Naoto Kato and Yasuyoshi Inagaki: Real-time Captioning based on Simultaneous Summarization of Spoken Monologue, Information Processing Society of Japan Research Report, SLP-62-10, pp. 51-56, Jul. 7-8, 2006.

### SUMMARY OF THE INVENTION

### Problems to be Solved by the Invention

However, the technique of non-patent document 1 mentioned above has the following problem.

The technique of non-patent document 1 determines a summarization unit, after dependency structures of not only a part to be determined as a summarization unit but also a part following that part have been analyzed. Therefore, the technique of non-patent document 1 has a problem that the processing efficiency becomes low because it re-analyzes the above-mentioned following part that becomes a part of the next summarization unit once again at the time when the next summarization unit is determined.

An object of the present invention is to provide a text processing system that settles a decline of processing efficiency in the case where a text not including break information is analyzed, which is the aforementioned problem.

### Means for Solving the Problem

In order to achieve this object, a text processing system which is one form of the present invention includes: a linking means for generating linked data by linking an acquired text to a back of a link object analysis result, the link object analysis result being a result of analysis of a text acquired prior to the acquired text; an analysis means for carrying out language analysis of the linked data using at least a portion of the link object analysis result; a determination means for determining a prescribed unit break included in the linked data based on an analysis result by the analysis means; and the link object analysis result is an analysis result after a break determined by the determination means.

Also, a text processing method which is another form of the present invention including: generating linked data by linking an acquired text to a back of a link object analysis result, the link object analysis result being a result of analysis of a text acquired prior to the acquired text; carrying out language analysis of the linked data using at least a portion of the link object analysis result; determining a prescribed unit break included in the linked data based on the analysis result; and the link object analysis result is an analysis result after the determined break.

Further, a text processing program which is yet another form of the present invention makes a computer execute: processing of generating linked data by linking an acquired text to a back of a link object analysis result, the link object analysis result being a result of analysis of a text acquired prior to the acquired text; processing of carrying out language analysis of the linked data using at least a portion of the link object analysis result; processing of determining a prescribed unit break included in the linked data based on the analysis result; and processing of the link object analysis result is an analysis result after the determined break.

### Effect of the Invention

Based on the present invention, a decline of processing efficiency can be settled when a text in which break information is not included is analyzed.

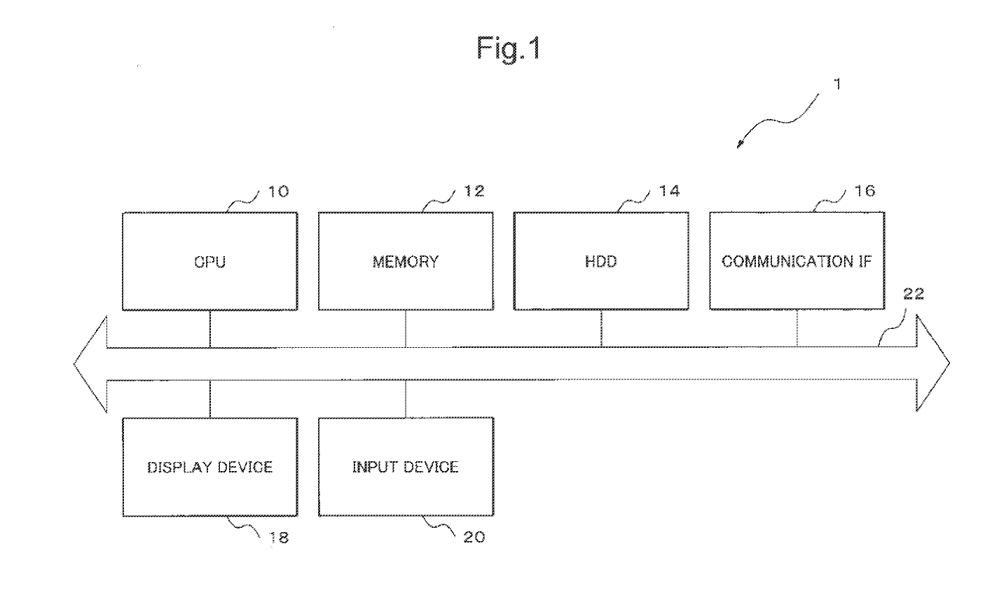

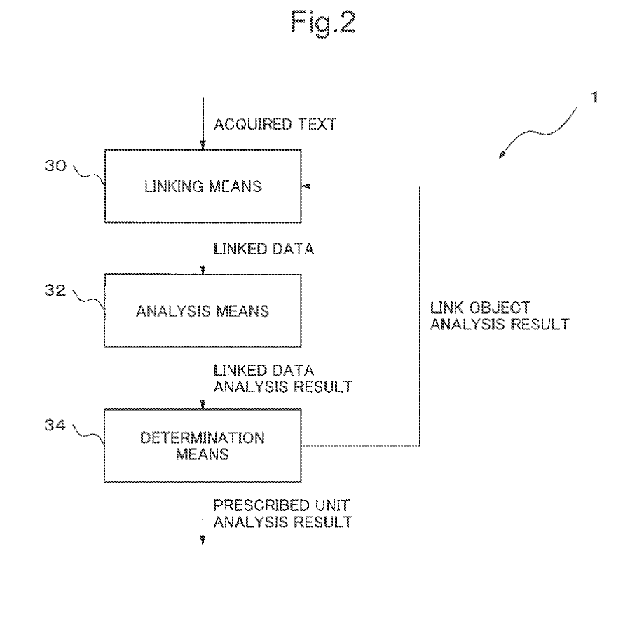

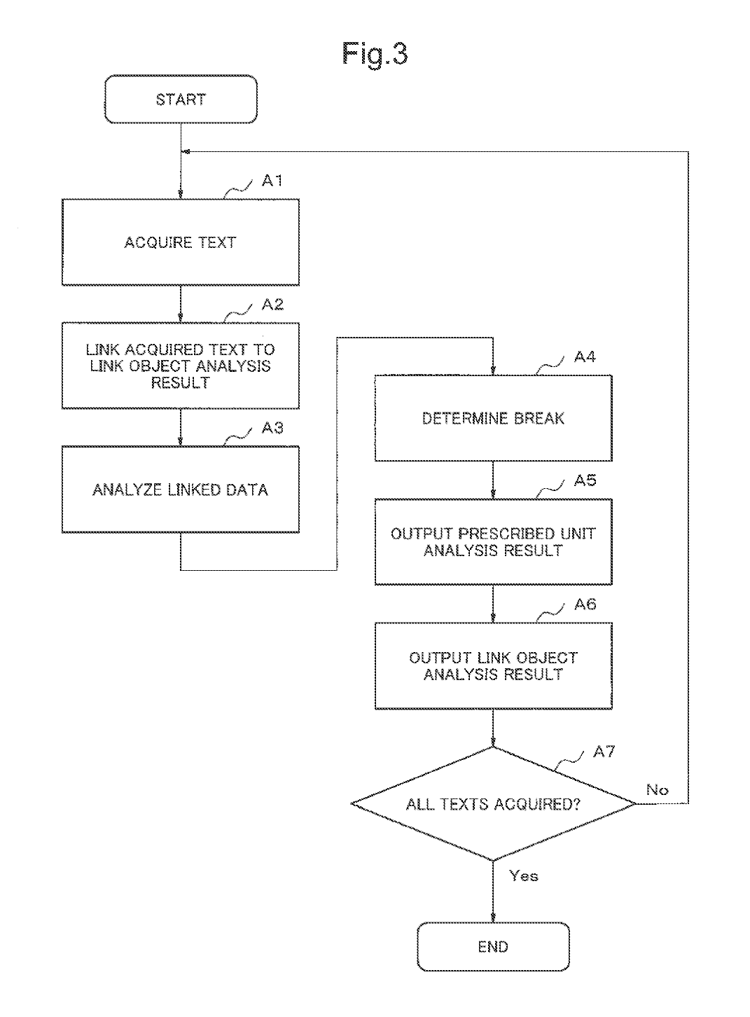

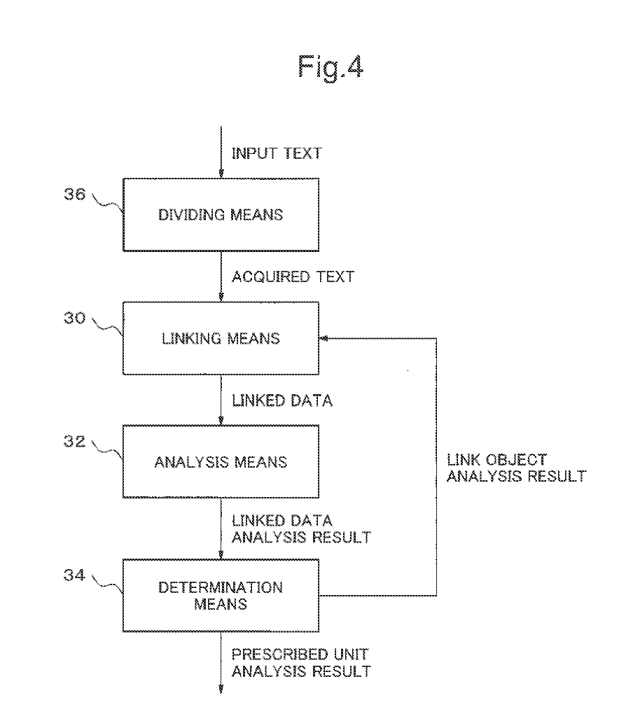

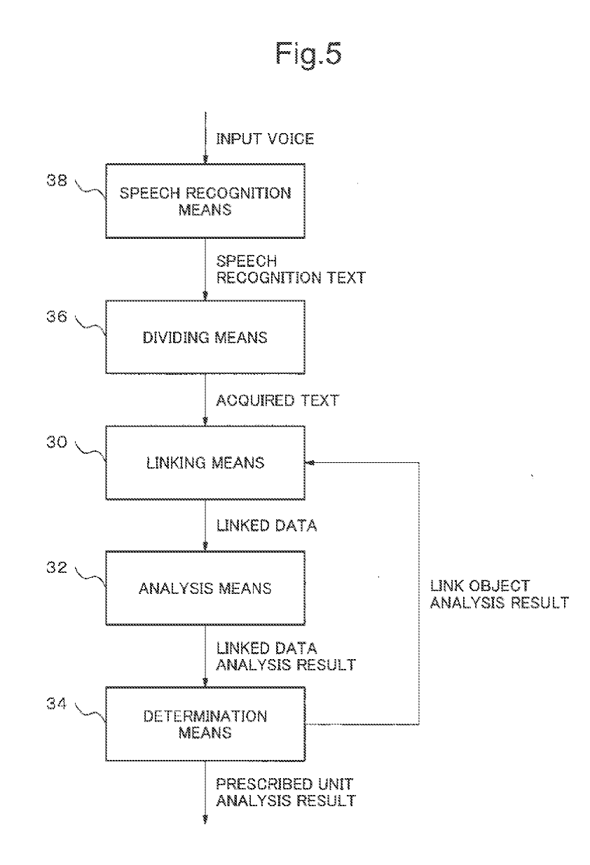

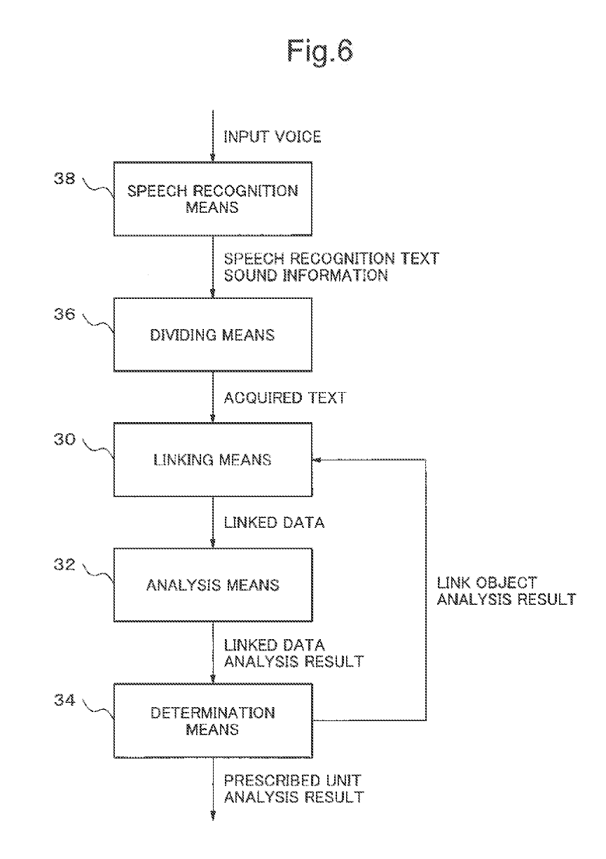

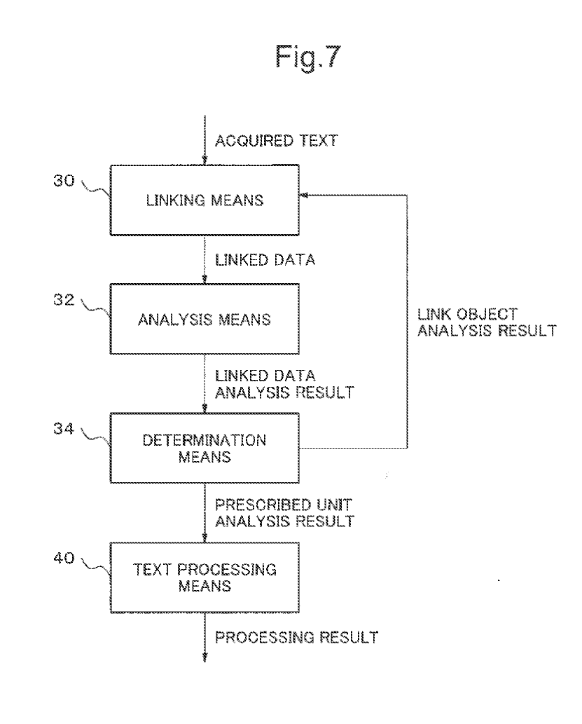

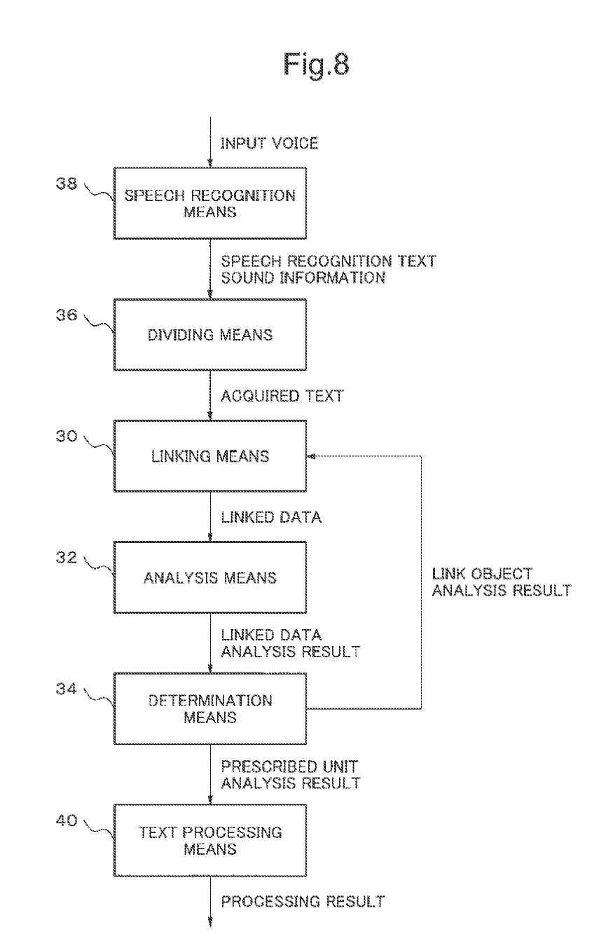

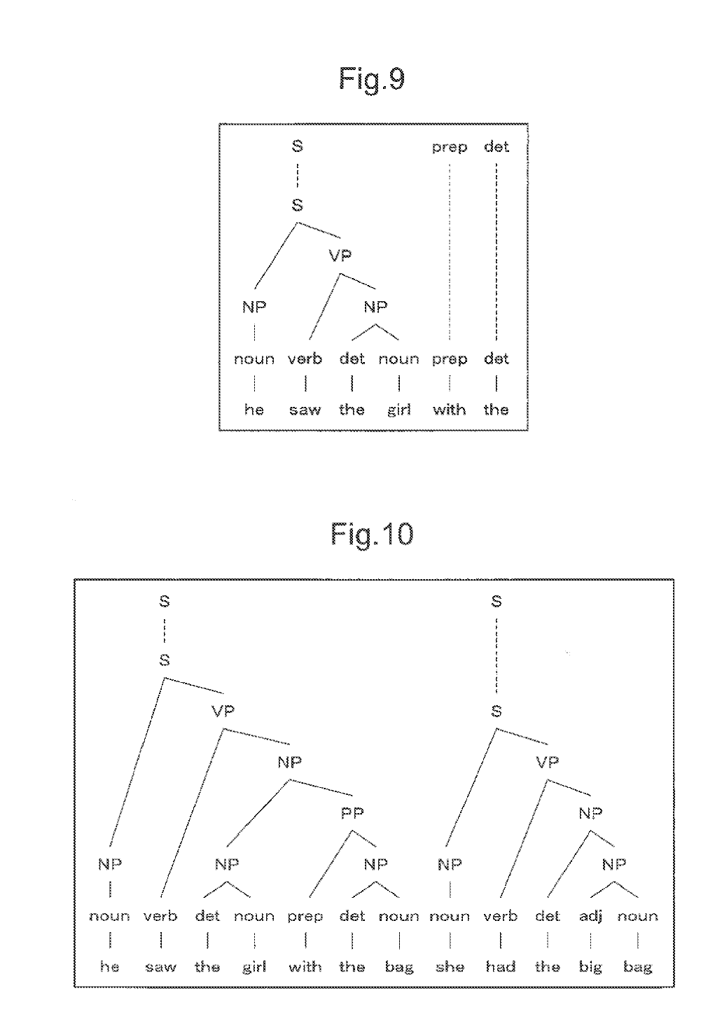

### BRIEF DESCRIPTION OF THE DRAWINGS

[FIG. 1] A hardware block diagram according to a first exemplary embodiment of the present invention

[FIG. 2] A block diagram showing a structure of the first exemplary embodiment of the present invention

[FIG. 3] A flow chart showing an operation of the first exemplary embodiment of the present invention

[FIG. 4] A block diagram showing a structure of a second exemplary embodiment of the present invention

[FIG. 5] A block diagram showing a structure of a third exemplary embodiment of the present invention

[FIG. 6] A block diagram showing a structure of a fourth exemplary embodiment of the present invention

[FIG. 7] A block diagram showing a structure of a fifth exemplary embodiment of the present invention

[FIG. 8] A block diagram showing a structure of a sixth exemplary embodiment of the present invention

[FIG. 9] A diagram illustrating a first example of the present invention

[FIG. 10] A diagram illustrating the first example of the present invention

### EXEMPLARY EMBODIMENT OF THE INVENTION

### Exemplary Embodiment 1

FIG. 1 is a diagram of an example of a hardware configuration of a text processing system 1 according to the first exemplary embodiment of the present invention.

As shown in FIG. 1, the text processing system 1 includes a CPU (Central Processing Unit) 10, a memory 12, a hard disk drive (HDD: Hard Disk Drive) 14, a communication interface (IF: Interface) 16 which communicates data via a network which is not illustrated, a display device 18 such as a display and an input device 20 including a keyboard and a pointing device such as a mouse. These components connect with each other via a bus 22, and input and output data.

FIG. 2 is a block diagram showing an example of a logical or functional exemplary configuration of the text processing system 1 of the first exemplary embodiment. As shown in FIG. 2, the text processing system 1 includes a linking means 30, an analysis means 32 and a determination means 34. For example, a function of the text processing system 1 may be realized such that a program is loaded in the memory 12 (refer to FIG. 1), and the CPU 10 executes the program. Meanwhile, all or a part of the functions of the text processing system 1 may be realized using hardware.

And, the text processing system 1 may include a recording medium, which is not illustrated, for storing a program executed by a computer such as the CPU 10.

The linking means 30 generates data (hereinafter, referred to as “linked data”) made by connecting a text which has been acquired (hereinafter, referred to as an “acquired text”) to the back of an analysis result (hereinafter, referred to as a “link object analysis result”) of a text that has been acquired before that, and outputs it to the analysis means 32. This link object analysis result is data outputted by the determination means 34 mentioned later. Meanwhile, when there is no analysis result of a previously-acquired text as is the case for a text acquired for the first time, the linking means 30 outputs the acquired text to the analysis means 32 as linked data.

The analysis means 32 receives the linked data from the linking means 30, and performs language analysis. As language analysis, for example, the analysis means 32 uses syntactic analysis techniques of the CYK (Cocke-Younger-Kasami) method and the chart (Chart) method based on a rule of CFG (Context-Free Grammar: context free grammar). Also, the analysis means 32 may employ techniques such as the morphological analysis (Morphological Analysis) of Japanese, Chinese and so on, the part-of-speech tagger (Part-of-Speech Tagger) or the like as language analysis.

Here, at the time when a language analysis is performed to linked data, the analysis means 32 uses at least part of a link object analysis result included in the linked data just as it is, that is, without re-analyzing it. For example, when a structure of a subtree has been obtained as a link object analysis result, the analysis means 32 performs language analysis of the linked data using the subtree which is closed within the link object analysis result just as it is.

Based on a structure of a prescribed unit which is included in an analysis result by the analysis means 32 (hereinafter, referred to as a “linked data analysis result”), the determination means 34 determines a prescribed unit break of the linked data analysis result. Specifically, the determination means 34 determines the position just before the structure of the last prescribed unit as a break. And, the determination means 34 treats a phrase, a clause, a sentence and a paragraph and so on as a prescribed unit of a linked data analysis result.

Further, the determination means 34 outputs an analysis result of the part after the break included in the linked data analysis result (this is a “link object analysis result” mentioned above) to the linking means 30. The link object analysis result is a part determined to constitute a part of the prescribed unit of a text acquired next.

And, the determination means 34 outputs the analysis result of the part before the break included in the linked data analysis result (hereinafter, referred to as a “prescribed unit analysis result”) to the display device 18. The prescribed unit analysis result is a part that has been determined that it is valid as a prescribed unit. Meanwhile, the determination means 34 may output a text part not including a result of language analysis based on the analysis means 32 to the display device 18. Also, the determination means 34 may store a prescribed unit analysis result into the memory 12 and the HDD 14, and may output it to another computer via the communication IF 16.

Meanwhile, when a structure of a prescribed unit is not included in a linked data analysis result, the determination means 34 determines that there are no breaks. Then, the determination means 34 outputs the whole of the linked data analysis result to the linking means 30.

Next, operations of the first exemplary embodiment for carrying out the present invention will be described in detail.

FIG. 3 is a flow chart showing an example of operations of the first exemplary embodiment.

As shown in FIG. 3, the linking means 30 acquires a text (Step A1).

Next, the linking means 30 links the acquired text to the back of a link object analysis result and generates linked data (Step A2). Then, the linking means 30 outputs the linked data to the analysis means 32. Meanwhile, when the linking means 30 acquires a text for the first time, there is no analysis result of a text acquired before that. Therefore, the linking means 30 makes the acquired text a linked data.

The analysis means 32 performs language analysis of the linked data which the linking means 30 has linked (Step A3). The analysis means 32 outputs a linked data analysis result which is a result of the language analysis to the determination means 34.

The determination means 34 determines a prescribed-unit break of the linked data analysis result which the analysis means 32 has performed analysis (Step A4).

Further, the determination means 34 outputs a prescribed unit analysis result which is the part before the break in the linked data analysis result to the display device 18. (Step A5).

Further, the determination means 34 outputs a link object analysis result which is the analysis result for the part after the break to the linking means 30 (Step A6).

Here, when not all the texts inputted from the input device 20 have been acquired (in Step A7, NO), the linking means 30 acquires the next text from the part just after the text acquired in previous Step Al (Step Al).

On the other hand, when the linking means 30 has acquired all of the texts inputted from the input device 20 (in Step A7, YES), the text processing system 1 finishes operating.

Further, when texts following the acquired text are inputted from the input device 20 to the linking means 30 newly after the operation has been finished, the linking means 30 may link the link object analysis result acquired finally to the text which is acquired at the beginning of the texts inputted newly.

Next, an effect of this exemplary embodiment will be described.

The text processing system 1 according to this exemplary embodiment links the next text to a link object analysis result which is a part following a prescribed-unit break, and performs language analysis using at least part of the link object analysis result just as it is when performing language analysis. Thus, the text processing system according to this exemplary embodiment prevents at least part of the following part of the break from being analyzed a plurality of times. For this reason, when a text in which break information is not included is analyzed, the text processing system 1 of this exemplary embodiment can settle a decline of processing efficiency. As a result, the text processing system 1 according to this exemplary embodiment can determine and output a prescribed unit of a text not including break information at a high speed.

### Exemplary Embodiment 2

FIG. 4 is a block diagram showing an example of an exemplary configuration of a text processing system of the second exemplary embodiment. Referring to FIG. 4, when compared with the first exemplary embodiment, the second exemplary embodiment of the present invention is different in a point that a dividing means 36 is added. Therefore, the detailed description of the other structures except for the dividing means 36 will be omitted.

The dividing means 36 divides a text (hereinafter, referred to as an “input text”) inputted from the input device 20 (refer to FIG. 1), and makes them be acquired texts. The dividing means 36 may divide a text every fixed character count, or fixed word count. Or, when a text is inputted in a streaming form, the dividing means 36 may sections the streaming form text in a regular interval and divides the text.

The linking means 30 acquires texts divided by the dividing means 36 successively as an acquired text. The other structures including the linking means 30 operate as is the case with the first exemplary embodiment.

Next, an effect of this exemplary embodiment will be described. In the second exemplary embodiment, a prescribed unit of a text not including break information can be determined and outputted at a high speed in common with the first exemplary embodiment.

Further, the linking means 30 of the second exemplary embodiment receives a text divided by the dividing means 36, that is, a text of a predetermined length. Therefore, compared with the first exemplary embodiment in which the length of a text to be linked may become long, it becomes possible for the linking means 30 of the second exemplary embodiment to generate linked data at a higher speed.

### Exemplary Embodiment 3

FIG. 5 is a block diagram showing an example of an exemplary configuration of a text processing system of the third exemplary embodiment. Referring to FIG. 5, compared with the second exemplary embodiment, the third exemplary embodiment of the present invention is different in a point that a speech recognition means 38 is added. Therefore, detailed description of the other structures except for the speech recognition means 38 will be omitted.

And, the input device 20 (refer to FIG. 1) in this exemplary embodiment is comprised of a microphone, for example. Voice data (hereinafter, referred to as “input voice”) is inputted from the input device 20 to the speech recognition means 38.

The speech recognition means 38 performs speech recognition of the input voice sequentially, and outputs a text (hereinafter, referred to as a “speech recognition text”) which is a result of the speech recognition.

The dividing means 36 receives the speech recognition text as an input text, sections it, and outputs acquired texts. (Hereinafter, it is supposed that an input text includes a speech recognition text) The other structures operate in common with the second exemplary embodiment.

Meanwhile, a text processing system of the third exemplary embodiment may combine the speech recognition means 38 and the dividing means 36 together as one speech recognition apparatus. For example, it is such a case where, when a pose beyond a fixed time emerges in input voice, a speech recognition apparatus outputs a speech recognition text successively as an earning text while performing sectioning there. In this case, a speech recognition apparatus functions as both of the speech recognition means 38 and the dividing means 36.

Next, an effect of the third exemplary embodiment of the present invention will be described.

In the third exemplary embodiment, a speech recognition text outputted by the speech recognition means 38 performing speech recognition of input voice is processed as an input text. Therefore, even when voice data is inputted, the third exemplary embodiment can determine a prescribed unit for a text which is a speech recognition result of this voice data at a high speed.

### Exemplary Embodiment 4

FIG. 6 is a block diagram showing an example of an exemplary configuration of a text processing system of the fourth exemplary embodiment. Compared with the third exemplary embodiment, the fourth exemplary embodiment is different in points that the speech recognition means 38 outputs not only a speech recognition text but also sound information obtained on the occasion of speech recognition, and that the determination means 34 uses the sound information for determination. Therefore, the detailed description of the other structures except for the speech recognition means 38 and the determination means 34 will be omitted.

Meanwhile, the sound information is a pose length of input voice, for example. When the sound information is a pose length, the determination means 34 determines a possible break point between a word and a word from a syntactic analysis result, and, when the pose length between the word and the other word is long, determines the point between the words as a break.

Also, the sound information may be talker information. When the sound information is the talker information, the determination means 34 judges a point where a talker is changed using the talker information given to a speech recognition result, and determines the point as a break.

Meanwhile, the dividing means 36 of the fourth exemplary embodiment may divide an input text (speech recognition text) using the sound information.

Next, an effect of the fourth exemplary embodiment of the present invention will be described.

In the fourth exemplary embodiment, when the determination means 34 determines a break, it also uses the sound information. Compared with the third exemplary embodiment that performs determination without using the sound information, the fourth exemplary embodiment can determine a break with a higher accuracy based on utilization of this sound information.

### Exemplary Embodiment 5

FIG. 7 is a block diagram showing an example of an exemplary configuration of a text processing system of the fifth exemplary embodiment. Compared with the first exemplary embodiment, the fifth exemplary embodiment is different in a point that a text processing means 40 is added. Therefore, detailed description of the other structures except for the text processing means 40 will be omitted.

The text processing means 40 performs text processing of a prescribed unit analysis result outputted from the determination means 34. The text processing means 40 translates a prescribed unit analysis result and outputs processing result data, for example. Also, the text processing means 40 may perform speech synthesis using a prescribed unit analysis result, and output voice of a prescribed unit analysis result as processing result data. Also, the text processing means 40 may extract reputation information using a prescribed unit analysis result, and output it as processing result data.

Next, an effect of the fifth exemplary embodiment of the present invention will be described.

In the fifth exemplary embodiment, the text processing means 40 performs text processing of a prescribed unit analysis result before a break determined by the determination means 34. Therefore, even when a text of the stream form is inputted, it becomes possible for the fifth exemplary embodiment to perform text processing with an appropriately divided unit.

### Exemplary Embodiment 6

FIG. 8 is a block diagram showing an example of an exemplary configuration of a text processing system of the sixth exemplary embodiment. The sixth exemplary embodiment has a structure made by combining the fourth exemplary embodiment and the fifth exemplary embodiment. Because operations of each structure are as those that have been described in the fourth exemplary embodiment and the fifth exemplary embodiment, detailed description will be omitted.

Next, an effect of the sixth exemplary embodiment of the present invention will be described.

In the sixth exemplary embodiment, the effects of the fourth exemplary embodiment and the fifth exemplary embodiment such as that, even when voice data of a stream form is inputted, text processing becomes possible with an appropriately divided unit.

### First Example

Next, a first example of the present invention will be described with reference to a drawing. This example is an example corresponding to the second exemplary embodiment for carrying out the present invention.

In this example, the input device 20 is a keyboard. And, a personal computer has the CPU 10, the memory 12 and the HDD 14. Further, the display device 18 is a display. The communication IF 16 is omitted in the description of this example.

First, an input text of “he saw the girl with the bag she had the big bag” is inputted from the keyboard which is the input device 20 to the dividing means 36.

The dividing means 36 divides this input text into, for example, groups each having six words supposing that a space is a delimiter of a word.

In order to output linked data to the analysis means 32, the linking means 30 acquires “he saw the girl with the” which is the first part divided by the dividing means 36 as an acquired text, and connects it with a link object analysis result which is an analysis result of a text which has been acquired just before it.

However, because a link object analysis result does not exist at this time, the linked data is “he saw the girl with the” of the acquired text.

The analysis means 32 performs language analysis to the linked data.

In this example, the analysis means 32 performs, as language analysis, syntactic analysis by the CYK method and the chart method based on a rule of CFG (context free grammar).

The CFG rule is expressed in the form of “A→a”. In this example, the analysis means 32 performs syntactic analysis of the text of the linked data according to CFG rules of “S→NP+VP”, “VP→VP+NP”, “NP→NP+PP”, “NP→det+noun”, “NP→adj+NP”, “PP→prep+NP”, “NP→noun” and “VP→verb”. Meanwhile, S represents a sentence, NP a noun phrase, VP a verb phrase, PP a past participle, det a determiner, noun a noun, adj an adjective, prep a preposition and verb a verb.

FIG. 9 is an example of an analysis result of the linked data “he saw the girl with the”. When expressed using a parenthesis, this analysis result will be “ (he (saw (the girl))) with the”. And, not only this structure but also various subtree structures occur during the language analysis. When a node (node) of the highest rank of the made-up structure is expressed by [ ], the analysis result of FIG. 9 becomes [S, prep, det].

In this example, the determination means 34 determines a sentence. When described more in detail, when a node of the highest rank is the structure of [S, S . . . and S, X], the determination means 34 determines the S structures existing in the left side of the last S a sentence. Meanwhile, here, S indicates a sentence, and X indicates a series of non-terminal symbols besides S. However, X may not exist.

For example, the determination means 34 determines the first S as a sentence when an analysis result is [S, S, X], and determines S of the part except [S, X] of the last part when it is [S, S . . . S, S, X] as one sentence. Also, the determination means 34 determines that there is no sentence existing when an analysis result is [S, X].

The top node of the analysis result of FIG. 9 becomes [S, prep, det]. Accordingly, the analysis result of FIG. 9 is the shape of [S, X]. Therefore, the determination means 34 determines that there is no sentence.

Therefore, the determination means 34 outputs nothing to the display device 18. And, the determination means 34 outputs “(he (saw (the girl))) with the” that is the whole body of the analysis result to the linking means 30 as a link object analysis result.

The linking means 30 acquires a next text of the text acquired first. In other words, the linking means 30 acquires “bag she had the big bag” which are six words from the seventh word to the twelfth word.

Further, the linking means 30 links this text to a back of the link object analysis result “(he (saw (the girl))) with the” including a structure of a subtree, and makes it be linked data.

The analysis means 32 performs language analysis to the linked data. Here, the subtree being closed within the six words from the first word to the sixth word “he saw the girl with the” has been created by the last analysis. Therefore, in this analysis, the analysis means 32 does not create the subtree. Meanwhile, specifically, the closed subtree is a portion corresponding to the two NPs in FIG. 9. The analysis means 32 analyzes other parts, and outputs an analysis result (refer to FIG. 10). As expressed using a parenthesis, this structure becomes “(he (saw ((the girl) (with (the bag))))) (she (had (the (big bag))))”.

As shown in FIG. 10 as an example, because the top nodes of the structure that has been built up is [S, S], the determination means 34 determines the most left S as a sentence. Therefore, the determination means 34 outputs “he saw the girl with the bag” determined as a sentence to the display which is the display device 18 as one unit. And, the determination means 34 outputs the analysis result of back parts from the break of a sentence “(she (had (the (big bag))))” to the linking means 30 as a link object analysis result. The linking means 30 links a next acquired text and this link object analysis result and generates linked data.

Thus, this example uses at least part of an analysis result of a link object analysis result analyzed before just as it is, and does not perform language analysis in an overlapping manner. Therefore, this example can perform processing at a high speed.

### Second Example

Next, the second example of the present invention will be described. This example corresponds to the sixth exemplary embodiment.

Here, this example configures the speech recognition means 38 and a dividing device 36 together as one speech recognition apparatus. Specifically, the speech recognition apparatus of this example performs speech recognition of an input voice and obtains a speech recognition text and sound information (it is supposed that sound information is a pose length in this example). Then, when the speech recognition apparatus detects that a pose beyond a fixed time inputs in the input voice based on the pose length of the sound information, the speech recognition apparatus outputs a text successively as an acquired text while dividing the speech recognition text by the pose. In other words, the speech recognition apparatus has the functions of both the speech recognition means 38 and the dividing device 36.

The input device 20 of this example is a microphone. When a speech sound of “he saw the girl with the bag she had the big bag” is inputted from the microphone, the speech recognition apparatus converts this sound into a speech recognition text.

Further, when a pose exists between “the” of the sixth word and “bag” of the seventh word, for example, the speech recognition apparatus divides the speech recognition text at the position, and outputs to the linking means 30 as an acquired text.

Therefore, the linking means 30 acquires the text of “he saw the girl with the” first, and acquires “bag she had the big bag” next.

After that, as the first example, the analysis means 32 analyzes a linked text as “he saw the girl with the”. And, the determination means 34 determines that there is no sentence included in the analysis result of this connection text, and outputs “(he (saw (the girl))) with the” that is the whole body of the analysis result to the linking means 30 as a link object analysis result. The linking means 30 acquires “bag she had the big bag” which is the next acquired text, and links it to the link object analysis result (“(he (saw (the girl))) with the”).

After that, as the first example, the determination means 34 outputs “he saw the girl with the bag” determined as a sentence to the text processing means 40 as a prescribed unit analysis result. The text processing means 40 translates this prescribed unit analysis result by a sentence unit, and outputs a translation result to a display which is the display device 18.

Thus, the analysis means 32 of this example analyzes linked data which the linking means 30 has linked. The determination means 34 determines a break using an analysis result by the analysis means 32, and outputs a result of determination as a sentence. Then, the text processing means 40 translates the output of the determination means 34. Therefore, even if the speech recognition apparatus of this example outputs a result of speech recognition as an acquired text based on a pose length different from a unit of a sentence about inputted stream sound, the text processing means 40 can translate the text at a high speed in units of a sentence.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2010-183996, filed on Aug. 19, 2010, the disclosure of which is incorporated herein in its entirety by reference.

### DESCRIPTION OF SYMBOL

1 Text processing system

10 CPU

12 Memory

14 HDD

16 Communication IF

18 Display device

20 Input device

22 Bus

30 Linking means

32 Analysis means

34 Determination means

36 Dividing means

38 Speech recognition means

40 Text processing means

1. A text processing system, comprising:
a linking unit which generates linked data by linking an acquired text to a back of a link object analysis result, the link object analysis result being a result of analysis of a text acquired prior to the acquired text;
an analysis unit which carries out language analysis of the linked data using at least a portion of the link object analysis result;
a determination unit which determines a prescribed unit break included in the linked data based on an analysis result of said analysis unit; and
the link object analysis result is an analysis result after a break determined by said determination unit.

2. The text processing system according to claim 1, wherein,
when the link object analysis result includes a subtree,
said analysis unit performs language analysis using a subtree being closed within the link object analysis result.

3. The text processing system according to claim 1, further comprising:
a dividing unit for dividing a text, wherein
said linking unit acquires a text divided by said dividing unit.

4. The text processing system according to claim 3, further comprising:
a speech recognition unit which performs speech recognition of voice, wherein
said dividing unit acquires a result which is performed speech recognition by said speech recognition unit.

5. The text processing system according to claim 4, wherein
said speech recognition unit outputs a result of speech recognition including sound information corresponding to the voice, and
at least one of said determination unit and said dividing unit uses the sound information.

6. The text processing system according to claims 1, comprising:
a text processing unit which performs text processing of an analysis result before a break determined by said determination means unit.

7. The text processing system according to claim 1, wherein,
said determination unit determines a position before a structure of a last prescribed unit as a break, when a structure of a prescribed unit is included in an analysis result of the linked data based on said analysis unit.

8. The text processing system according to claim 1, wherein
said determination unit determines a break using a unit of a sentence or a clause of an analysis result of the linked data.

9. A text processing method, comprising:
generating linked data by linking an acquired text to a back of a link object analysis result, the link object analysis result being a result of analysis of a text acquired prior to the acquired text;
carrying out language analysis of the linked data using at least a portion of the link object analysis result;
determining a prescribed unit break included in the linked data based on the analysis result; and
the link object analysis result is an analysis result after the determined break.

10. A computer readable medium embodying a 0program, said program causing a text processing system which includes a computer to perform a method, said method comprising:
generating linked data by linking an acquired text to a back of a link object analysis result, the link object analysis result being a result of analysis of a text acquired prior to the acquired text;
carrying out language analysis of the linked data using at least a portion of the link object analysis result;
determining a prescribed unit break included in the linked data based on the analysis result; and
the link object analysis result is an analysis result after the determined break.

11. A text processing system, comprising:
a linking means for generating linked data by linking an acquired text to a back of a link object analysis result, the link object analysis result being a result of analysis of a text acquired prior to the acquired text;
an analysis means for carrying out language analysis of the linked data using at least a portion of the link object analysis result;
a determination means for determining a prescribed unit break included in the linked data based on an analysis result of said analysis means; and
the link object analysis result is an analysis result after a break determined by said determination means.
